(19) United States
(12) Patent Application Publication
(10) Pub. No.: US 2023/0022686 A1
(43) Pub. Date: Jan. 26, 2023

(54) Fluoropolymer Compositions Including Glass Microspheres Functionalized with Functional, Fluorinated Silane Compounds

(71) Applicant: 3M INNOVATIVE PROPERTIES COMPANY, St. Paul, MN (US)

(72) Inventors: Michael H. Mitchell, Edina, MN (US); Miguel A. Guerra, Woodbury, MN (US); Stephen E. Amos, Minneapolis, MN (US); Jarod R. Lowry, Eagan, MN (US)

(21) Appl. No.: 17/756,977

(22) PCT Filed: Dec. 8, 2020
(86) PCT No.: PCT/IB2020/061643

§ 371 Date: Jun. 7, 2022

Related U.S. Application Data
(60) Provisional application No. 62/947,798, filed on Dec. 13, 2019.

(51) Int. Cl. C08K 5/5419; C08K 5/54; C08K 7/28; C08K 9/06

(52) U.S. Cl. CPC C08K 5/5419; C08K 5/5406; C08K 7/28; C08K 9/06

(57) ABSTRACT

Fluoropolymer compositions containing glass microspheres are described. The glass microspheres are surface-treated with functional, fluorinated silane compounds of the formula X—R_{f}—(O)ₚ—(CH₂)ₘ—Si—Y₃, wherein X is selected from the group consisting of CF₂═CF—O—, CH₂═CH—, CH₂═CHCH₂—, CH₂═CHCH₂—O—, and CH₂═CHCH₂—O—CH₂—.

### FIELD

The present disclosure relates to compositions that include fluoropolymers and glass microspheres functionalized with functional, fluorinated silane compounds.

### SUMMARY

Briefly, in one aspect, the present disclosure provides a composition comprising a fluoroelastomer and surface-treated microspheres. The surface-treated microspheres comprise a functional, fluorinated silane compound covalently bonded to a surface of a hollow glass microsphere. The functional, fluorinated silane compound is a silane according to Formula III:

X—R_{f}—(O)ₚ—(CH₂)ₘ—Si—Y₃ (III)

wherein: X is selected from the group consisting of CF₂═CF—O—, CH₂═CH—, CH₂═CHCH₂—, CH₂═CHCH₂—O—, and CH₂═CHCH₂—O—CH₂—; R_{f} is a perfluoro(alkylene) group having 1 to 8 carbon atoms and, optionally, at least one catenary heteroatom selected from the group consisting of O and N; p is 0 or 1; m is an integer from 2 to 5; and Y is —Cl or —O(CH₂)ₓCH₃, where x is an integer from 0 to 3.

In some embodiments, the fluoroelastomer is a peroxide-curable fluoroelastomer. In some embodiments, the fluoroelastomer is cured.

The details of one or more embodiments of the invention are also set forth in the description below. Other features, objects, and advantages of the invention will be apparent from the description and from the claims.

### DETAILED DESCRIPTION

Fluoroelastomers, including both partially fluorinated and perfluoroelastomers, have many properties that make them suitable materials for many applications. Such materials may have one or more of the following properties: resistance to degradation at high temperatures, resistance to degradation from contact with solvents, and low glass transition temperatures. However, relative to other polymers, fluoroelastomers tend to be more expensive and have higher densities (e.g., greater than 1.8 gm/cc), which can limit their application.

Glass microspheres, such as hollow glass bubbles, have been incorporated into a variety of polymers to reduce weight. However, attempts to incorporate such microspheres in fluoroelastomers, particularly partially-fluorinated elastomers, have had limited success. For glass bubbles, there can be poor compatibility with the fluoroelastomers leading to poor dispersions and a reduction in mechanical properties.

The present inventors discovered that glass microspheres that were functionalized with certain functional, fluorinated silane compounds could be used to create good, stable dispersions with fluoroelastomers. In addition, the inventors discovered that, in addition to having lower densities, cured fluoroelastomer compositions containing such functionalized microspheres had improved mechanical properties relative to similar compositions having either no microspheres or untreated microspheres.

Generally, the compositions of the present disclosure comprise a fluoroelastomer and hollow glass microspheres that have been functionalized with a functional, fluorinated silane compound.

Generally, the fluoroelastomer is not particularly limited. The fluoroelastomer may be perfluorinated or partially fluorinated. As used herein, in a perfluorinated polymer, the carbon-hydrogen bonds along the backbone of the polymer are all replaced with carbon-fluorine bonds and optionally some carbon-chlorine bonds. It is noted that the backbone of the polymer excludes the sites of initiation and termination of the polymer. As used herein, in a partially fluorinated polymer, the polymer backbone comprises at least one carbon-hydrogen bond and at least one carbon-fluorine bond. Again, the backbone excludes the sites of initiation and termination of the polymer. In some embodiments, highly fluorinated fluoroelastomers may be used, i.e., wherein at least 50% of polymer backbone comprises C—F bonds. In some embodiments, at least 60, 70, 80, or even 85% of the polymer backbone comprises C—F bonds or even at least 90, 95, or even 99% of the polymer backbone comprises C—F bonds.

In some embodiments, the fluoroelastomers may be derived from one or more fluorinated monomer(s) such as tetrafluoroethylene (TFE), vinyl fluoride (VF), vinylidene fluoride (VDF), hexafluoropropylene (HFP), pentafluoropropylene, trifluoroethylene, trifluorochloroethylene (CTFE), perfluorovinyl ethers, perfluoroallyl ethers, or combinations thereof.

In some embodiments, the perfluorovinyl ethers are those of Formula I:

CF₂═CFO(R_{f1}—O)ₚR_{f2} (I)

where R_{f1} is a linear or branched perfluoroalkylene radical groups comprising 2-6 carbon atoms; R_{f2} is a perfluoroalkyl group comprising 1 to 6 carbon atoms; and p is an integer from 0 to 10. Exemplary perfluorovinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), and combinations thereof.

In some embodiments, the perfluoroallyl ethers can be those of Formula II

CF₂═CFCF₂O(R_{f1}O)ₛ(R_{f1}O)ₜR_{f2} (II)

where each R_{f1} is independently a linear or branched perfluoroalkylene radical groups comprising 2-6 carbon atoms; R_{f2} is a perfluoroalkyl group comprising 1 to 6 carbon atoms; and s and t are, independently, integers selected from 0 to 10. Exemplary perfluoroallyl ether monomers include: perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and combinations thereof.

As is known by those of skill in the art, the fluoroelastomer may include small amounts of other copolymerizable monomers, which may or may not contain fluorine substitution, e.g. ethylene, propylene, butylene and the like. When present, these additional monomers can be used in amounts of not greater than 25 mole percent, in some embodiments less than 10 mole percent or even less than 3 mole percent of the fluoroelastomer.

In some embodiments, the fluoroelastomer can be a random copolymer, which is amorphous, meaning that there is an absence of long-range order (in long-range order the arrangement and orientation of the macromolecules beyond their nearest neighbors is understood). In some embodiments, the fluoroelastomer can be a block copolymer in which chemically different blocks or sequences are covalently bonded to each other, wherein the blocks have different chemical compositions and/or different glass transition temperatures. In some embodiments, the block copolymer comprises a first block, or A block, which is a semi-crystalline segment; and a second block, or B block, which is an amorphous segment.

Typically, the fluoroelastomers comprise cure sites that act as reaction sites for crosslinking. In some embodiments, the fluoroelastomers may be polymerized in the presence of chain transfer agents and/or cure site monomers to introduce cure sites into the fluoroelastomer. Typically, the fluoroelastomer comprises at least 0.05, 0.1, 0.5, 1, or even 2% by mole of cure sites and at most 10, or even 5% by mole of cure sites based on the total moles of monomers used to form the fluoroelastomer.

Exemplary chain transfer agents include: iodo-chain transfer agents, and bromo-chain transfer agents. Exemplary cure-site monomers may comprise at least one of a bromine, iodine, and/or nitrile cure moiety.

Exemplary cure site monomers may be derived from one or more compounds of the formula: (a) CX₂═CX(Z), wherein: (i) each X is independently H or F; and (ii) Z is I, Br, R_{f}˜U wherein U═I or Br and R_{f}=a perfluorinated or partially perfluorinated alkylene group optionally containing O atoms; or (b) Y(CF₂)_{q}Y, wherein: (i) Y is Br or I or Cl and (ii) q=1-6. In addition, non-fluorinated bromo- or iodo-olefins, e.g., vinyl iodide and allyl iodide, can be used.

In some embodiments, the cure site monomers comprise nitrile-containing cure moieties. Useful nitrile-containing cure site monomers include nitrile-containing fluorinated olefins and nitrile-containing fluorinated vinyl ethers.

Glass Microspheres.

Glass microspheres such as hollow glass microspheres (also commonly known as “glass microbubbles”, “glass bubbles”, “hollow glass beads”, or “glass balloons”) are useful as additives for polymeric formulations. However, such microspheres have poor compatibility with fluoropolymers, particularly, partially fluorinated polymers. Therefore, in the present application, the microspheres are functionalized by reacting them with a functional, fluorinated silane compound.

Hollow glass microspheres can be made by techniques known in the art. In one embodiment, a milled frit, commonly referred to as “feed”, which contains mineral components of glass and a blowing agent (e.g., sulfur or a compound of oxygen and sulfur) is heated at high temperatures. Upon heating, the blowing agent causes expansion of the molten frit to form hollow glass microspheres. In one embodiment, the frit is filtered or sorted by size prior to making the hollow glass microspheres, which can result in a plurality of hollow glass microspheres having a controlled particle size distribution, which is known in the art.

When making hollow glass microspheres, the batch may have any composition that is capable of forming a glass. In some embodiments, on a total weight basis, the batch comprises from 50 to 90 percent of SiO₂. In some embodiments, the composition may include one or more of an alkali metal oxide (for example, Na₂O or K₂O, e.g., from 2 to 20 percent); B₂O₃ (e.g., from 1 to 30 percent); from 0.005-0.5 percent of sulfur (for example, as elemental sulfur, sulfate or sulfite); from 0 to 25 percent divalent metal oxides (for example, CaO, MgO, BaO, SrO, ZnO, or PbO); from 0 to 10 percent of tetravalent metal oxides other than SiO₂ (for example, TiO₂, MnO₂, or ZrO₂); trivalent metal oxides (for example, Al₂O₃, Fe₂O₃, or Sb₂O₃, e.g., from 0.5 to 10 percent); and from 0 to 15 percent of oxides of pentavalent atoms (for example, P₂O₅ or V₂O₅). Additional ingredients may be included to provide particular properties or characteristics (for example, hardness or color) to the resultant hollow glass microspheres.

The “average true density” of hollow glass microspheres is the quotient obtained by dividing the mass of a sample of hollow glass microspheres by the volume of that mass of hollow glass microspheres as measured by a gas pycnometer. For the purposes of this disclosure, average true density is measured using a pycnometer following a similar method as disclosed in ASTM D2840-69, “Average True Particle Density of Hollow Microspheres”. Although not particularly limited, in some embodiments, the glass microspheres of the present disclosure have an average true density of at least 0.1 grams per cubic centimeter (g/cc). In some embodiments, the average true density is at least 0.2 or even at least 0.3 g/cc. In some embodiments, the average true density is no greater than 1.1 g/cc, e.g., no greater than 1.0, or even no greater than 0.8 g/cc. In some embodiments, the average true density is from 0.2 to 0.8, e.g., from 0.3 to 0.7 g/cc.

The median size of the glass microspheres, also called the D50 size, where 50 percent by volume of the hollow glass microspheres in the distribution are smaller than the indicated size, can be determined by laser light diffraction by dispersing the hollow glass microspheres in deaerated, deionized water. Laser light diffraction particle size analyzers are available, for example, under the trade designation “MASTERSIZER 2000” from Malvern Instruments, Malvern, UK. Generally, the glass microspheres have a D50 size of less than 500 microns, e.g., less than 200 microns, or even less than 100 microns. In some embodiments, the glass microspheres have a D50 size is in the range from 10 to 60 micrometers (in some embodiments from 15 to 40 micrometers, 10 to 25 micrometers, 20 to 45 micrometers, 20 to 40 micrometers or 40 to 50 micrometers).

Suitable glass microspheres can be obtained commercially and include those marketed by 3M Company, St. Paul, Minn., under the trade designation “3M GLASS BUBBLES” (e.g., grades S60, S60HS, iM30K, iM16K, S38HS, S38XHS, K42HS, K46, and H50/10000). Other suitable hollow glass microspheres can be obtained, for example, from Potters Industries, Valley Forge, Pa., (an affiliate of PQ Corporation) under the trade designations “SPHERICEL HOLLOW GLASS SPHERES” (e.g., grades 110P8 and 60P18) and “Q-CEL HOLLOW SPHERES” (e.g., grades 30, 6014, 6019, 6028, 6036, 6042, 6048, 5019, 5023, and 5028), from Silbrico Corp., Hodgkins, Ill. under the trade designation “SIL-CELL” (e.g., grades SIL 35/34, SIL-32, SIL-42, and SIL-43), and from Sinosteel Maanshan Inst. of Mining Research Co., Maanshan, China, under the trade designation “Y8000”.

Generally, the glass microspheres are functionalized by reacting them with a functional, fluorinated silane compounds according to Formula III, below.

X—R_{f}—(O)ₚ—(CH₂)ₘ—Si—Y₃ (III)

wherein: X is selected from CF₂═CF—O—, CH₂═CH—, CH₂═CHCH₂—, CH₂═CHCH₂—O—, and CH₂═CHCH₂—O—CH₂—,

R_{f} is a perfluoro(alkylene) group having 1 to 8 carbon atoms and, optionally, at least one catenary heteroatom selected from the group consisting of O and N;

p is 0 or 1;

m is an integer from 2 to 5; and

Y is —Cl or —O(CH₂)ₓCH₃, where x is an integer from 0 to 3.

In some embodiments, X can be CH₂═CHCH₂—, CF₂═CF—O—, or CH₂═CHCH₂—O—. In some embodiments, m can be an integer from 2 to 4 or from 2 to 3. In some embodiments, Y can be —OCH₃.

Generally, X represents the functional group of the functional, fluorinated silane compound. Thus, e.g., when X is CH₂═CHCH₂—, a compound of Formula III may be referred to as an allyl-functional fluorinated silane compound.

Independent of other selections, in some embodiments, p is 0, and the functional, fluorinated silane compound is one according to Formula IV:

X—R_{f}—(CH₂)ₘ—Si—Y₃. (IV)

Independent of other selections, in some embodiments, R_{f} is a linear or branched perfluoro(alkylene) group, e.g., a linear perfluoro(alkylene) group having the formula (CF₂)ₙ wherein n is an integer from 1 to 8. In some embodiments, n is 3 or 4, e.g., n is 4. In some embodiments, R_{f} comprises at least 5 carbon atoms, and five or six carbon atoms of R_{f} are bonded together to form a ring.

Independent of other selections, in some embodiments, Y is —O(CH₂)ₓCH₃. In some embodiments, x is 0 or 1, i.e., Y is selected from the group consisting of —OCH₃ and —OCH₂CH₃.

Independent of other selections, in some embodiments, m is 2 or 3, e.g., m=2.

In some embodiments, the functional, fluorinated silane compound is one according to Formula IV, wherein Y is —O(CH₂)ₓCH₃; x is 0 or 1 (e.g., x=0); n=3 or 4 (e.g., n=4); and m=2 or 3 (e.g., m=2).

In some embodiments, the functional, fluorinated silane compound is one according to Formula V,

X—C₄F₈—CH₂—CH₂—Si—(OCH₃)₃ (V)

which corresponds to Formula III, where R_{f} is (CF₂)ₙ wherein n is 4, p is 0, m is 2, and Y is —O(CH₂)ₓCH₃ wherein x is 0. In some embodiments, X is CH₂═CH—, and the partially-fluorinated silane bonding agent is CH₂═CH—C₄F₈—CH₂—CH₂—Si—(OCH₃)₃.

Examples of the functional, fluorinated silane compounds of the present disclosure include:

CF₂═CF—O—C₄F₈—CH₂CH₂—SiCl₃ (MV4ETCS);

CF₂═CF—O—C₄F₈—CH₂CH₂—Si(OCH₃)₃ (MV4ETMS);

CF₂═CF—O—C₄F₈—CH₂CH₂CH₂—SiCl₃ (MV4PTCS);

CF₂═CF—O—C₄F₈—CH₂CH₂CH₂—Si(OCH₃)₃ (MV4PTMS);

CH₂═CHCH₂—C₄F₈—CH₂CH₂CH₂—SiCl₃ (AC4PTCS);

CH₂═CHCH₂—C₄F₈—CH₂CH₂CH₂—Si(OCH₃)₃ (AC4PTMS);

CH₂═CHCH₂—O—C₄F₈—O—CH₂CH₂CH₂—SiCl₃ (AEC4EPTCS);

CH₂═CHCH₂—O—C₄F₈—O—CH₂CH₂CH₂—Si(OCH₃)₃ (AEC4EPTMS);

CH₂═CH—C₄F₈—CH₂CH₂—SiCl₃ (VC4ETCS); and

CH2=CH—C₄F₈—CH₂CH₂—Si(OCH₃)₃ (VC4ETMS).

One exemplary method of making useful functional, fluorinated silane compounds begins with a compound having the fluorinated group (R_{f}) linking a desired functional group (X) to a group having a terminal alkene. This compound may then be monohydrosilylated with trichlorosilane using a platinum catalyst. This synthetic method is illustrated by the generic Scheme 1 below:

X—R_{f}—(O)ₚ—(CH₂)_{q}—CH═CH₂+HSiCl₃(Pt)→X—R_{f}—(O)ₚ—(CH₂)_{q}—CH₂—CH₂—Si—Cl₃

wherein R_{f}, X, and p are as defined herein for Formula III, and q is 0 to 3. In some embodiments, the starting compound is symmetrical, i.e., X is CH═CH₂—(CH₂)_{q}—(O)ₚ—. For example, if p and q are 0, then X is CH₂═CH—; if p is 0 and q is 1, then X is CH₂═CHCH₂—; and if p is 1 and q is 1, then X is CH₂═CHCH₂—O—. In some embodiments, the starting compound is not symmetrical, as the functional group, X, may be independently selected from the group having a terminal alkene. For example, in some embodiments, X is CF₂═CF—O—.

In some methods, such trichlorosilane compounds can be reacted with an alcohol to produce easier to handle trialkoxy silanes. This synthetic method is illustrated by the generic Scheme 2 below wherein a linear alcohol is used as an exemplary alcohol.

X—R_{f}—(O)ₚ—(CH₂)_{q}—CH₂—CH₂—Si—Cl₃+HO(CH₂)ₓCH₃→X—R_{f}—(O)ₚ—(CH₂)_{q}—CH₂—CH₂—Si—(O(CH₂)ₓCH₃)₃.

Generally, the level of surface treatment will depend on a number of factors including the specific composition of the functional silane and its molecular weight. In some embodiments, the surface-treated microspheres comprise at least 0.1 wt. % of the functional silane based on the total weight of the microspheres and the silane. In some embodiments, the surface-treated microspheres comprise at least 0.2, at least 0.5, or even at least 1 wt. % of the functional silane. In some embodiments, the surface-treated microspheres comprise no greater than 5, e.g., no greater than 2, or even no greater than 1.5 wt. % of the functional silane.

Generally, the amount of surface-treated microspheres included in the fluoroelastomer composition is not particularly limited. For example, in some embodiments, amounts as low as 0.1 parts by weight of surface-treated microspheres per 100 parts by weight of resin (i.e., 0.1 phr), 0.5 or even 1 phr, may be used. However, to achieve the desired amount of weight reduction, in some embodiments, higher loadings, e.g., at least 5, at least 10, or even at least 20 phr of the surface-treated microspheres may be included. Generally, the upper limit is not particularly limited, and can be selected based on the balance between the desired weight reduction and any detrimental effects on the mechanical properties associated with high microsphere loadings. In some embodiments, the surface-treated microspheres of the present disclosure may be present at up to 150 phr, e.g., up to 100 phr, or up to 50 phr. In some embodiments, the surface treated microspheres are present in amounts ranging from 10 to 100 phr, e.g., 20 to 100 phr, or 20 to 50 phr; where all ranges are inclusive of the end-points.

### EXAMPLES

Glass Bubbles (GB-A). Microspheres functionalized with VC4ETMS were produced by the following method.

In a hood, a 50/50 wt. % slurry of iM16K Glass Bubbles (from 3M Company, St. Paul, Minn., USA) in isopropanol was made in a beaker. The slurry was continuously stirred on a hot plate to keep the bubbles in a vortex (in solution), at room temperature. Two percent by weight of CH₂═CH—C₄F₈—CH₂CH₂—Si(OCH₃)₃ (VC4ETMS) functional, fluorinated silane based on the total weight of the silane and glass bubbles was then added to the slurry. While stirring, the slurry was heated to 60° C. for 30 minutes.

After heating to facilitate covalent bonding of the silane to the glass bubble, the slurry was allowed to cool to room temperature, while stirring. The slurry was then separated via vacuum filtration using a Watlow filter with the appropriate pore size for retaining the bubble (iM16K glass bubbles have an average particle size of 18 microns). The retained bubbles were then washed on the vacuum filter with 3×50 ml aliquots of distilled water three times to remove any residual isopropanol. The treated bubbles were then spread on an aluminum pan and dried in a solvent oven at 110° C. for two hours. The resulting glass bubbles had a final coat weight of about 1 wt. % based on the total weight of the treated glass bubbles.

Glass Bubbles GB-B were prepared in the same manner except the microspheres were functionalized with AC4PTMS.

Example EX-1. Approximately 40 grams of GB-A glass bubbles were charged to a 1 L plastic Nalgene bottle. Then approximately 800 g of a 26.7% solids solution of a vinylidene fluoride/hexafluoropropylene dipolymer latex (FPO 3600 fluoropolymer from 3M Company) was added to the bottle. The mixture was shaken by hand for five minutes, then placed on a roller for four hours. After rolling, the samples were then placed in a minus 40° C. freezer for 16 hours to coagulate the latex.

Comparative Example CE-1 was prepared in the same manner except untreated iM16K Glass Bubbles were used.

Example EX-2. Approximately 20 grams of GB-A glass bubbles were charged to a 1 L plastic Nalgene bottle. Then approximately 350 g of a 28.4% solids solution of a vinylidene fluoride/hexafluoropropylene/tetrafluoroethylene terpolymer latex (FPO 3820 fluoropolymer from 3M Company) was added to the bottle. The mixture was shaken by hand for five minutes, then placed on a roller for four hours. After rolling, the samples were then placed in a minus 40° C. freezer for 16 hours to coagulate the latex.

Example EX-3 was prepared in the same manner except the GB-B glass bubbles were used.

Comparative Example CE-2 was prepared in the same manner except the untreated glass bubbles were used.

Following the freeze coagulation, there appeared to be a uniform distribution of the treated glass bubbles throughout the container for Examples EX-1, EX-2 and EX-3. For CE-1, there was a 1.2 cm (0.5 inch) thick layer of coagulated material near the top of the plastic container where the untreated glass bubbles appeared to have a localized domain, with the remaining polymer settled at the bottom of the container. Similar separation was observed with CE-2.

Distribution Test Method: After freeze coagulation of the mixture, the incorporation of the functionalized glass bubbles was evaluated as follows. A first sample of the wet composition was extracted from a location 2.5 cm (1 inch) below the top level of latex (the “top sample”) and a second sample of the wet composition was extracted from a location 2.5 cm (1 inch) above the bottom of the container (the “bottom sample”). The weight of these samples (Wet wt.) were measured. These samples were dried in an oven at 130° C. for sixteen hours to remove water and the weight was remeasured (Dry wt.). The dried samples were then taken up in approximately 15 grams of MIBK to separate the fluoropolymer from the glass bubbles. The weight of the glass bubbles (GB wt.) in the top and bottom samples were then measured. The weight percent of the glass bubbles (GB wt. %) was then calculated as the weight of the glass bubbles divided by the dry weight of the samples. If a uniform slurry with good distribution were obtained, the weight percent of the glass bubbles should be approximately the same in the top and bottom samples.

The compositions of CE-1, CE-2 and EX-1, EX-2, and EX-3 were evaluated according to the Distribution Test Method. The results are summarized in Table 1, where the GB wt. % is based on the weight of the glass bubbles divided by the weight of the dry sample.

TABLE 1
Distribution of glass bubbles in samples.

| | Glass | Top sample | | | Bottom sample | | |
|---|---|---|---|---|---|---|---|
| | bubble | Dry | GB | GB | Dry | GB | GB |
| ID | treatment | wt. (g) | wt.(g) | wt. % | wt. (g) | wt. (g) | wt. % |
| CE-1 | None | 2.7 | 0.57 | 21% | 2.9 | 0.06 | 2% |
| EX-1 | VC4ETMS | 3.0 | 0.68 | 22% | 2.72 | 0.51 | 18% |
| CE-2 | None | 5.68 | 2.1 | 37% | 6.68 | 0.06 | 0.5% |
| EX-2 | VC4ETMS | 4.49 | 1.43 | 31% | 8.36 | 0.64 | 8% |
| EX-3 | AC4PTMS | 3.82 | 0.83 | 22% | 5.76 | 0.82 | 14% |

Cured Composition Method. Curable compositions were prepared from the lattices of EX-1 and CE-1. The dried polymer/glass bubble compositions were passed through a two-roll mill to homogenize the samples. They were then compounded with carbon black (available under the trade designation N990, obtained from Cancarb Ltd, Medicine Hat, Alta., Canada); a co-agent (triallyl-isocyanurate, available under the trade designation “TAIC” from Nippon Kasei Chemical Co. Ltd., Tokyo, Japan), a peroxide curative (2,5-dimethyl-2,5-di(t-butylperoxy)-hexane, 50% active, available under the trade designation “VAROX DBPH-50” from Vanderbilt Chemicals, LLC., Norwalk, Conn.) and zinc stearate (Zn—S) based on the formulations in Table 2, which also includes the density of the dried composition. An additional sample was prepared in the same manner except that no glass bubbles were included.

TABLE 2
Compounded compositions.

| Example | CE-3 | CE-4 | EX-4 |
|---|---|---|---|
| Glass bubbles (g) | 0 | 20 | 20 |
| GB Treatment | N/A | none | VC4ETMS |
| GB Source | N/A | CE-1 | EX-1 |
| Polymer (g) | 100 | 100 | 100 |
| TAIC | 3 | 3 | 3 |
| DBPH-50 | 2 | 2 | 2 |
| Carbon black (g) | 10 | 10 | 10 |
| Zn Stearate (g) | 0.7 | 0.7 | 0.7 |
| Density (g/cc) | 1.84 | 1.46 | 1.44 |

Cure rheology tests were carried out using the uncured, compounded samples of Table 2 with a rheometer available under the trade designation “PPA 2000” from Alpha technologies, Akron, Ohio, in accordance with ASTM D 5289-93a at 177° C., no pre-heat, 12 minutes elapsed time, and a 0.5 degree arc. Both the minimum torque (M_{L}) and highest torque attained during a specified period of time when no plateau or maximum torque (M_{H}) was obtained were measured. The time for the torque to reach a value equal to M_{L}+0.5 (M_{H}−M_{L}), (t′50), and the time for the torque to reach M_{L}+0.9 (M_{H}−M_{L}), (t′90) were measured. The results are listed in Table 3.

TABLE 3
Cure rheology.

| Example | CE-3 | CE-4 | EX-4 |
|---|---|---|---|
| M_{L}, Minimum Torque (Nm) | 0.0 | 0.0 | 0.0 |
| M_{H}, Maximum Torque (Nm) | 0.8 | 1.5 | 1.6 |
| Δ torque (Nm) | 0.7 | 1.5 | 1.6 |
| t′50, Time to 50% cure - minutes | 0.8 | 0.7 | 0.7 |
| t′90, Time to 90% cure - minutes | 1.4 | 1.0 | 1.1 |
| tan δ M_{L} | 2.14 | 1.85 | 1.95 |
| tan δ M_{H} | 0.14 | 0.15 | 0.15 |

Samples of the uncured compositions of Table 2 were press cured at 177° C. (350° F.) for ten minutes and the physical properties of the press cured samples were measured. The results are summarized in Table 4A.

TABLE 4A
Properties of samples press-cured at 177°
C. (350° F.) for ten minutes.

| Example | CE-3 | CE-4 | EX-4 |
|---|---|---|---|
| Tensile (MPa) | 12.2 | 10.2 | 8.8 |
| Elongation at break (%) | 555 | 513 | 430 |
| 100% modulus (MPa) | 1.1 | 2.3 | 3.2 |
| Hardness, Shore A | 50 | 67 | 70 |

The press cured samples were post-cured at 232° C. (450° F.) for four hours. Tensile, elongation at break, and modulus data were gathered from samples cut to Die D specifications at room temperature in accordance with ASTM 412-06a. Shore A hardness was measured from tensile Die D samples in accordance with ASTM D2240-05. These physical properties of the post-cured samples are summarized in Table 4B.

TABLE 4B
Properties of press cured samples after post cure at
232° C. (450° F.) for four hours.

| Example | CE-3 | CE-4 | EX-4 |
|---|---|---|---|
| Tensile (MPa) | 13.8 | 12.8 | 12.0 |
| Elongation at break (%) | 510 | 409 | 351 |
| 100% modulus (MPa) | 1.3 | 4.0 | 4.5 |
| Hardness, Shore A | 54 | 70 | 72 |

As shown in Table 2, the addition of glass bubbles delivered the desired reduction in density. However, as shown in Tables 4A and 4B, significant improvements in the mechanical properties including the elongation at break and the 100% modulus were achieved when the glass bubbles were treated with functional, fluorinated silane compounds. These improvements indicate that the surface-treated microspheres are crosslinked into the polymer network resulting in a higher modulus and reduced elongation at break.

1. A composition comprising a fluoroelastomer and surface-treated microspheres, wherein the surface-treated microspheres comprise a functional, fluorinated silane compound covalently bonded to a surface of a hollow glass microsphere.

2. The composition of claim 1, wherein the functional, fluorinated silane compound is a compound according to Formula III:
X—R_{f}—(O)ₚ—(CH₂)ₘ—Si—Y₃ (III)
wherein: X is selected from the group consisting of CF₂═CF—O—, CH₂═CH—, CH₂═CHCH₂—, CH₂═CHCH₂—O—, and CH₂═CHCH₂—O—CH₂—,
R_{f} is a perfluoro(alkylene) group having 1 to 8 carbon atoms and, optionally, at least one catenary heteroatom selected from the group consisting of O and N;
p is 0 or 1;
m is an integer from 2 to 5; and
Y is —Cl or —O(CH₂)ₓCH₃, where x is an integer from 0 to 3.

3. The composition of claim 2, wherein X is selected from the group consisting of CH₂═CHCH₂—, CF₂═CF—O—, or CH₂═CHCH₂—O—.

4. The composition of claim 2, wherein m is 2 or 3.

5. The composition of claim 2, wherein Y is —O(CH₂)ₓCH₃.

6. The composition of claim 5, wherein x is 0.

7. The composition of claim 2, wherein p is 0.

8. The composition of claim 2, wherein R_{f} is a linear or branched perfluoro(alkylene) group.

9. The composition of claim 8, wherein R_{f} is a linear perfluoro(alkylene) group having the formula (CF₂)ₙ wherein n is an integer from 1 to 8.

10. The composition of claim 2, wherein R_{f} comprises at least 5 carbon atoms, and five or six carbon atoms of R_{f} are bonded together to form a ring.

11. The composition of any one of claims 1 to 3, wherein the fluoroelastomer is a partially fluorinated elastomer.

12. The composition of claim 1, wherein the fluoroelastomer is a perfluorinated elastomer.

13. The composition of claim 1, further comprising a peroxide.

14. The composition of claim 1, further comprising a curative.

15. The composition of claim 1, wherein the fluoroelastomer is uncured.

16. The composition of claim 1, wherein the fluoroelastomer is cured.

17. The composition of claim 1, wherein the surface-treated microspheres comprise at least 0.5 wt. % and no greater than 2 wt. % of the functional, fluorinated silane compound covalently bonded to a surface of the hollow glass microspheres, based on the total weight of the silane compound and the microspheres.

18. The composition of claim 1, wherein the composition comprises 10 to 100 parts by weight of the surface-treated microspheres per 100 parts by weight of the fluoroelastomer.
